(19) United States
(12) Patent Application Publication
(10) Pub. No.: US 2014/0297385 A1
(43) Pub. Date: Oct. 2, 2014

(54) DETERMINING LOYALTY ACCOUNT STATUS AND SALES INCENTIVES USING CHECK-IN INFORMATION

(71) Applicant: Michael Joseph Ryan, San Jose, CA (US)

(72) Inventor: Michael Joseph Ryan, San Jose, CA (US)

(21) Appl. No.: 14/301,073

(22) Filed: Jun. 10, 2014

Related U.S. Application Data
(63) Continuation of application No. 14/228,177, filed on Mar. 27, 2014.
(60) Provisional application No. 61/805,899, filed on Mar. 27, 2013.

(51) Int. Cl. G06Q 30/02

(52) U.S. Cl. CPC G06Q 30/0226
USPC 705/14.27

(57) ABSTRACT

There is provided systems and method for merchant anonymous check-in at a merchant location. A user may bring a user device to a merchant location where the user may have previously checked-in at the merchant location and perform an anonymous check-in at the merchant location. Thus, the user device may provide the merchant location with a different or obfuscated identifier so the merchant does not identify the user from the previous check-in. Once the user has checked-in with the merchant, the user may make service requests for the merchant's staff, such as do not approach or service assistance. Additionally, the merchant may inform the user about loyalty account services and automatically enroll the user in a loyalty account. If the user has discounts, gift cards, or other benefits in a digital wallet, the merchant may offer the user other benefits related to the benefits in the wallet to increase sales.

### CROSS-REFERENCE TO RELATED APPLICATIONS

This application is a continuation of U.S. application Ser. No. 14/228,177, filed Mar. 27, 2014, which claims priority to the filing date of U.S. Provisional Patent Application Ser. No. 61/805,899, filed Mar. 27, 2013, both of which are incorporated by reference in their entirety.

### TECHNICAL FIELD

Example embodiments of the present application relate generally to check-in at a merchant location, and more specifically to providing a user with anonymous check-in, service request, and sales incentive options when utilizing a user device to check-in with a merchant.

### BACKGROUND

Merchants may offer check-in services that enable a user to perform functions with the merchant after completing a check-in with the merchant. A check-in with a merchant may include establishing communication with the merchant so that the merchant receives some user information. Often the user information corresponds to a token or identifier for the user, which may be transmitted from a user device of the user o a cloud service holding the token or identifier. Thus, the merchant may maintain contact and complete processes with the user using the identifier. Once the merchant possesses the identifier for the user, the merchant may store the identifier, often with other user information such as a name, address, account information, etc., so that the user may be identified in the future. Thus, if the user visits the merchant again and completes a check-in with the merchant, the user's information may be recalled using the identifier. However, this prevents the user from achieving anonymity with the merchant if the user wishes to use check-in services. Thus, the user may forego using check-in services if the user would like to stay anonymous.

After arriving at a merchant location, a user may wish to engage staff members at the merchant location for service requests. For example, one user may wish to locate specific items for sale. Another user may be browsing and wish to be left alone. Still other users may wish to find out if a certain staff member they know or have been recommended is workings and available for assistance. However, without conveying this information to all of the merchant staff members, the user may either spend a considerable amount of time locating their desired assistance or constantly be hassled by staff members. This can lead to a bad shopping experience, poor sales, or a frustrated customer. Moreover, the staff member and/or the merchant may receive negative feedback from the user, may not be recommended by the user, or the user may not be fully informed of the items and/or services offered by the merchant.

A merchant may offer loyalty account services that offer benefits and/or discounts to a user while at a merchant location. For example, the user may be a preferred customer that receives discounts, service upgrades, or specialized help to the user. The loyalty accounts may further provide the merchant with knowledge of the user's past shopping habits in order to provide more targeted benefits to the user. However, users may not be immediately aware of loyalty accounts when visiting a merchant location. Even though a merchant may advise the user of the loyalty accounts when arriving at the merchant location or paying for items, the user may forego opting in to the loyalty account due to the time expenditure required to enroll. Thus, the user may lose valuable discounts, sale offers, rebates, etc., that the user would prefer. Additionally, even though a user may have a loyalty account or a digital wallet having benefits (e.g., gift cards, coupons, etc.) for the merchant location, a user may be unaware of potential savings when arriving at the merchant. Thus, the user may let valid benefits expire and a merchant may miss a sale that the merchant would otherwise have made when the benefit was available to the user.

### BRIEF DESCRIPTION OF THE DRAWINGS

FIG. 1 is a block diagram of a networked system suitable for implementing the process described herein, according to an embodiment;

FIG. 2 is an exemplary system environment displaying a user opting for an anonymous check-in with a user device when visiting a merchant location, according to an embodiment;

FIG. 3 is an exemplary system environment displaying a user device selecting interactions with merchant staff after a check-in at a merchant location, according to an embodiment;

FIG. 4 is an exemplary system environment displaying a user device providing sales incentives to a user after a check-in at a merchant location, according to an embodiment;

FIG. 5 is a flowchart of an exemplary process for anonymous check-in at a merchant location, according to an embodiment;

FIG. 6 is a flowchart of an exemplary process for merchant staff interactions through a user device check-in at a merchant location, according to an embodiment;

FIG. 7 is a flowchart of an exemplary process for providing sales incentive information after a user device check-in at a merchant location, according to an embodiment; and

FIG. 8 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide anonymous user check-in at a merchant location. In other embodiments, methods may provide merchant staff interactions through a user device check-in at a merchant location or sales incentive information after a user device check-in at a merchant location. Systems suitable for practicing methods of the present disclosure are also provided.

In various embodiments, a user may utilize a user device to complete an anonymous check-in with a merchant where the user has previously checked-in, although this may also be the first time the user has checked in with the merchant or at the specific location of the merchant (where the user has checked in with the merchant at other store location(s)). During a first visit to a merchant location for a merchant, a user may perform a check-in with the merchant by transmitting check-in information having an identifier for the user from a user device. In other embodiments, the user may instruct a cloud service having the identifier to transmit the identifier to the merchant. The check-in information may be transmitted to a merchant device at the merchant location of the merchant. However, in other embodiments, a server, such as a merchant server and/or a payment provider server, may offer check-in services for the merchant location. The identifier may be stored by the merchant with user information associated with the user. Thus, the merchant may be able to identify the user through the identifier and may be able to recall the additional user information through the identifier. However, in certain embodiments, the user may not have previously checked-in with the merchant.

When the user wishes to perform another check-in with the merchant at a merchant location (e.g., on a future visit), the user may select to perform an anonymous check-in if the user would prefer to not use the previous identifier for check-in with the merchant, thereby recalling any information previously stored with the identifier by the merchant, but still receive some benefits of a merchant check-in. In other embodiments, the user may wish to utilize an anonymous check-in with the merchant when first visiting the merchant so that the merchant does not possess an identifier often used or associated with the user. Thus, the user may utilize a user device to select an anonymous check-in with the merchant. Selection of the anonymous check-in option may be done prior to visiting the merchant location so that any automatic check-in is done anonymously. In other embodiments, the user may select an anonymous check-in while completing check-in information with the merchant at the merchant location, such as when prompted to check-in at the merchant location. An anonymous check-in may utilize an identifier, token, or other single use information that the user has not previously used with the merchant, such as a secondary user device identifier, a different account identifier, or a newly generated identifier. In other embodiments, an identifier or other information for the user that has been previously used or uses often may be obfuscated, such as by scrambling, adding, removing, and/or changing the identifier.

Once checked-in anonymously, the merchant may treat the user as a first time user at the merchant location. A first time user may correspond to a status as a new customer or a new visiting to a merchant location. Based on being a first time user, the merchant may offer the user several options. The user may see merchant information, sales associate help information, sales and/or discount offers, or other informational requests. Additionally, the user may be given the option to join or create a loyalty account with the merchant. The user may also be provided other benefits as a result of the check-in, such as payment services.

In various embodiments, a user, after checking in with a merchant at a merchant location, may request various interactions with merchant staff members, such as sales associates, at the merchant location. The user may make the requests corresponding to merchant staff members either through a “normal” check-in where a previously used identifier is utilized in the check-in information when completing the check-in, or may make these requests after an anonymous check-in. Once a check-in is completed by the merchant for the merchant location (e.g., through the merchant device or through a server offering check-in services to the merchant location), the user may transmit a service request corresponding to the merchant staff at the merchant location using a user device. The service request may be communicated to the merchant staff using staff devices. For example, a staff device may be a point of sale terminal, a user device, or an intercom system.

The service request by the user may comprise a “do not bother” message or other message that informs the merchant staff to not approach the user. Thus, the message may be broadcast to all the merchant staff members so that the user may be left alone. However, in other embodiments, the service request may correspond to a request by the user for service from the merchant staff at the merchant location. The request may be general to any member or members of the merchant staff to assist the user. However, the request may also be specific to a certain member of the merchant staff, for example, an employee named Alice. The user may know Alice, have been recommended Alice, or previously worked with or reviewed Alice to know the member the user is requesting. In other embodiments, the user may be presented with the members of the merchant staff along with information (e.g., biography, specialties, etc.) that may enable the user to make a choice for a member of the staff. The service request may then be transmitted to a terminal in an area of the requested member of the merchant staff or directly to a device (e.g., mobile phone, pager, etc.) possessed by the requested member.

In other embodiments, the service request may be specific to an area, item, or service, such as a request for assistance in a golf section or help purchasing new shoes. The service request may also be to not approach the user in the specific area, item, or service, but allow merchant staff members to approach the user if the user is not in that area, or shopping for that item or service. In such embodiments, the service request may be sent to a terminal or device specific to that area, item, or service, such as a terminal in the golf section or a user device of a shoe salesman.

After transmitting the service request, the user may be alerted through the user device of assistance information. The assistance information may correspond to a setting, such as a “do not bother” setting. However, the assistance information may also include information about the requested service, such as a name, picture, or approximate wait time for a member of the merchant that will be assisting the user.

Once a user is checked-in with a merchant, sales incentives the user has with the merchant, such as benefits, discounts, gift cards, etc. with the merchant, may be determined by the merchant. The merchant may determine additional sales incentives that the merchant can offer the user that are related to the determined sales incentives. These additional sales incentives may correspond to additional time extensions of discounts, added value to discounts or gift cards, or other benefits that may increase the likelihood the user utilizes the determined sales incentives. Both the determined and the additional sales incentives may be communicated to the user.

One sales incentive determined for the user may correspond to a loyalty account status for a loyalty account with a merchant. If the user has a loyalty account, the additional sales incentives may include discounts or benefits for using the loyalty account. However, if the user has not enrolled in the loyalty account, the merchant may transmit a request for enrollment in the loyalty account. The merchant may request additional user information if the user wishes to enroll in the loyalty account, such as a name, address, payment information/preferences, etc., or the merchant may complete enrollment in the loyalty account using the check-in information supplied by the user or service provider. Once the user is enrolled in the loyalty account, the user may be provided loyalty account information through an email, text, digital notification, wallet card, keychain card, and/or a printout.

If the user possesses a previous loyalty account with the merchant, the merchant may view past interactions with the user at the merchant location and offer discounts corresponding to those past interactions. Past interactions may include previous visit times, items purchased, and/or amounts spent.

In various embodiments, the determined sales incentives may include user benefits in a digital wallet. For example, a benefit in a digital wallet may correspond to a coupon, rebate offer, gift card, etc. Thus, additional user benefits the merchant may offer the user corresponding to the determined user benefits may include value increases, discounts, and/or time extensions when using the determined user benefits.

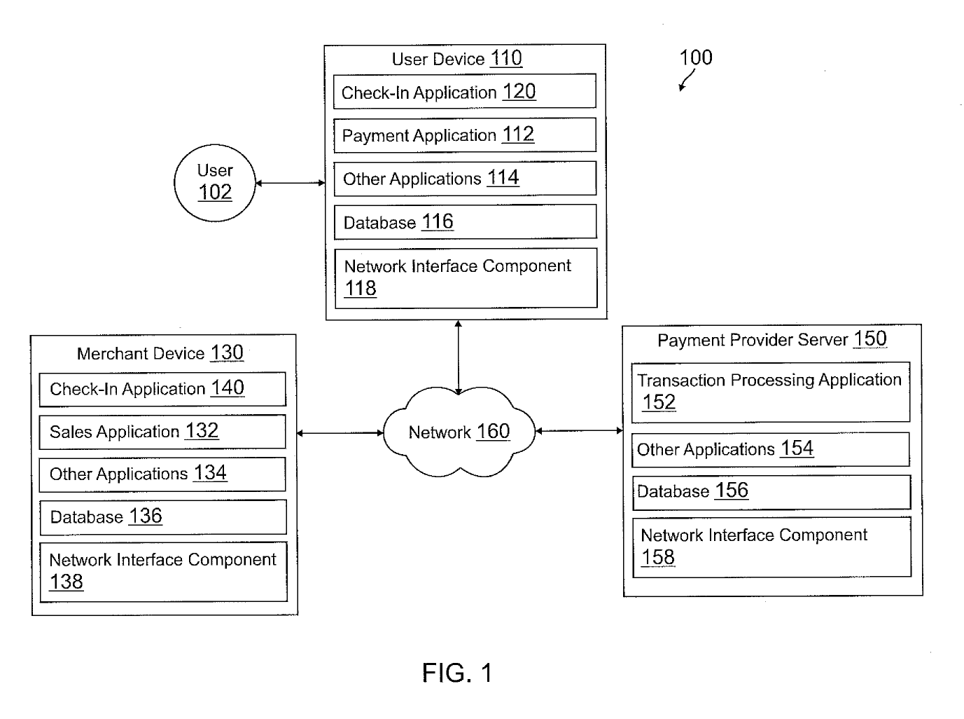

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant device 130, and a payment provider server 150 in communication over a network 160. User 102 may utilize user device 110 to check-in with merchant device 130, either directly or through a service offered by payment provider server 150. Check-in may be done anonymously or may be done with a previous identifier for user 102. Once checked-in with merchant device 130, user 102 may engage in transactions, receive information, and/or transmit requests to merchant device 130. Payment transactions may be completed using payment provider server 150.

User device 110, merchant device 130, and payment provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with merchant device 130 and/or payment provider server 150. For example, in one embodiment, user device 110 may be implemented as a personal computer (PC), a smart phone, laptop computer, wristwatch with appropriate computer hardware, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 120, a payment application 112, other applications 114, a database 116, and a network interface component 118. Check-in application 120, payment application 112 and other applications 114 may correspond to processes, procedures, and/or applications executable by a hardware processor, for example, a software program. In other embodiments, user device 110 may include additional or different software as required.

Check-in application 120 may be used by user 102 of user device 110 to establish a connection between user device 110 and merchant device 130. Check-in application 120 may correspond to an application utilized by user device 110 with merchant device 130 to complete a check-in with merchant device 130. The check-in with merchant device 130 may correspond to a process to log in to a user account of user 102 with merchant device 130 and/or payment provider server 150. In other embodiments, the check-in may provide and/or verify identity of user 102, including transmission of an identifier for user 102 and/or user device 110. In other embodiments, check-in application 120 may instruct a cloud service offering check-in services (e.g., payment provider server 140) to transmit an identifier and/or other check-in information to merchant device 130. Thus, check-in application 120 may pass check-in information to merchant device 130 or may instruct payment provider server 140 to pass check-in information to merchant device 130, where the check-in information may include at least an identifier for user 102.

Check-in application 120 may provide for an anonymous check-in with merchant device 130. In such embodiments, check-in application 120 may provide a user interface that includes an option for the user to check-in anonymously with merchant device 130. The option may present as a menu option, selectable box or icon, prompt when a check-in opportunity is available, etc. Thus, user 102 may select the anonymous check-in preference prior to transmitting the check-in information to merchant device 130 or when prompted on a check-in request for merchant device 130. User 102 may also select an option with check-in application 120 that may make all check-ins anonymous with merchant device 130 and/or other merchants.

If user 102 selects the anonymous check-in option, check-in application 120 of user device 110 may obfuscate an identifier used in the check-in information so that merchant device 130 will not recognize the identifier as an identifier belonging to user 102 and/or user device 110. Even if user device 110 has not previously checked-in with merchant device 130, the identifier may be obfuscated so that storage of the obfuscated identifier will not be associated with user 102 since it will not be reused in the future for check-in with merchant device 130. Check-in application 120 may obfuscate the identifier by scrambling the data of the identifier, rearranging, adding, removing, and/or changing values of the data in the identifier, or other method that enables user 102 to hide user 102's identity when checking in with merchant device 130. In other embodiments, user device 110 may use an identifier that has not been previously used to check-in with merchant device 110, such as a new or different identifier. In such embodiments, check-in application 120 may retain a log of the identifier used for check-in with merchant device 130 and/or other devices so that it is not used duplicitously.

Check-in application 120 may correspond to an application available over the Internet for download from merchant device 130 and/or payment provider server 150. In other embodiments, check-in application 120 may correspond more generally to a browser application configured to communicate with service provider server 130. Check-in application 120 may also correspond to an application integrated and/or built in to an operating system of user device 110. The check-in may be completed directly with merchant device 130 (e.g., through a local connection with merchant device 130, such as through a Bluetooth, near field communication, Bluetooth Low Energy, wireless, or wired connection) or over network 160 with merchant device 130 and/or payment provider server 150.

Check-in application 120 may receive wireless communications (e.g., Bluetooth, Bluetooth Low Energy, near field communication, etc.) from merchant device 130 and/or payment provider server 150 when visiting a merchant location corresponding to merchant device 130 to alert user 102 of check-in services and/or complete a check-in process with merchant device 130. Thus, check-in application 120 may execute in the background of an operating system of user device 110 and be configured to establish connections with merchant device 130 with or without user input. In other embodiments, user 102 may engage check-in application 120 to complete check-in when arriving at a merchant location. In such embodiments, check-in application 120 may establish a connection with merchant device 130 and/or payment provider server 150 to complete the check-in. If an anonymous check-in is selected, check-in information passes to merchant device 130 and/or payment provider server 150 may include the unknown identifier. In certain embodiments, the check-in information may be limited so that a name, address, email, phone number, or other personal information is not passed to merchant device 130 and/or payment provider server 140.

Once a check-in application has completed a check-in with merchant device 130, check-in application 120 may transmit and/or receive information. As previously discussed, user 102 may select an anonymous check-in with merchant device 130. Thus, merchant device 130 may transmit first time benefits to user 102 through user device 110 if merchant device associates user 102 with a first time user status, as will be discussed in more detail herein. User 102 may view and interact with the benefits using check-in application 120, which may include loyalty account enrollment, merchant information, available sales, discounts, and/or rebates, and/or sales associate help requests.

For example, check-in application 120 may include an interface allowing user 102 to transmit service requests corresponding to merchant staff at a merchant location of merchant device 130 (e.g., a sales associate help request). Check-in application 120 may communicate the service request to merchant device 130 for distribution to the merchant staff, as will be discussed in more detail herein. User 102 may utilize check-in application 120 to transmit a message instructing the merchant staff to not approach user 102 at the merchant location (e.g., a do not approach message). However, user 102 may also utilize check-in application 120 to transmit requests for service from a member of the merchant staff at the merchant location. The request may be specific to a certain member, for example, if user 102 has interacted with, knows of, or chooses a specific merchant staff member. Thus, check-in application 120 may include an input form to enter a name or identifier for the specific member of the merchant staff or may include a list of available merchant staff members. The service request for assistance may be routed generally to the merchant staff or to the specific member of the merchant staff, as will be discussed in more detail herein.

In other embodiments, user 102 may utilize check-in application 120 to transmit a service request that is specific to a certain area, item, and/or service at a merchant location corresponding to merchant device 130. For example, user 102 may request assistance in a bakery department, with tennis racquets, or for a car service. Check-in application 120 may provide for entry of these options or may provide a list of available areas, items, and/or services for user 102 to select. Additionally, check-in application 120 may alert user 102 of the results of the service request, such as assistance information. Assistance information may include a setting selected by user 102, such as a “do not approach” or “assistance requested in shoes” setting, and may further include a name, picture, and/or approximate wait time for a member of the merchant staff that will be assisting user 102.

In various embodiments, after user 102 checks-in with merchant device 130, user device 110 may receive sales incentives from merchant device 130, as will be explained in more detail herein. Sales incentives may correspond to incentives that user 102 may utilize at a merchant location corresponding to merchant device 130. Sales incentives may increase the likelihood user 102 may purchase items at the merchant location. In certain embodiments, the sales incentives may correspond to a loyalty account offered by merchant device 130. If user 102 has not previously enrolled in a loyalty program and does not have a loyalty account, merchant device 130 may transmit a request to enroll in the loyalty account to user 102 through check-in application 120. If user 102 accepts the request, merchant device 130 may complete the enrollment, as will be explained in more detail herein. In certain embodiments, merchant device 130 may request additional information from user 102 for enrollment in the loyalty account, such as a name, address, payment card information, personal information, etc. User 102 may enter the information through forms, menus, and/or options provided in an interface of check-in application 120. Once enrolled in the loyalty account, user 102 may receive confirmation and loyalty account information in an email, text, in a digital notification within check-in application 120, or as a wallet card, a keychain card, and/or a printout.

Once a loyalty account for user 102 is determined or established, user 102 may receive discount offers corresponding to that loyalty account. The discount offers may be determined by previous behavior of user 102, as will be explained in more detail herein. Additionally, user 102 may have a digital wallet stored on user device 110 or with merchant device 130/payment provider server 150. Merchant device 130 may transmit benefits available in the digital wallet to user 102 to view in check-in application 120, as well as other benefits that may be related to the benefits available in the digital wallet, as will be explained in more detail herein.

Payment application 112 may be used, for example, to provide a convenient interface to permit user 102 to select payment options and provide payment for items and/or services. For example, payment application 112 may be implemented as an application having a user interface enabling the user to enter payment options for storage by user device 110, provide payment on checkout of an item and/or service with merchant device 130, and complete a transaction for the item with merchant device 130 and/or payment provider server 150. In certain embodiments, payment application 112 may correspond more generally to a web browser configured to view information available over the Internet or access a website corresponding to a payment provider. Payment application 112 may utilize user financial information, such as a credit card, bank account, or other financial account. Additionally, payment application 112 may provide payment for items and/or services using a user account with the payment provider, such as payment provider server 150. Payment application 112 may include cross-linking, allowing user 102 to identify a user account through an identifier for a separate user account (e.g. identifying a user account through a debit card account number). Payment application 112 may further include options to store transaction histories for purchased items and/or services, such as receipts, for later use. Thus, payment application 112 provides an interface enabling user 102 to provide proof of purchase for an item/service to a merchant.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 140, or other types of applications. Other applications 114 may also include email, texting, voice and IM applications that allow a user to send and receive emails, calls, texts, and other notifications through network 140. In various embodiments, other applications 114 may include financial applications, such as banking, online payments, money transfer, or other applications associated with payment provider server 150. Additionally, other application may include browser applications, social media applications, and/or mapping/check-in applications where not provided by one or more of check-in application 120 and payment application 112. Other applications 114 may contain other software programs, executable by a processor, including a graphical user interface (GUI) configured to provide an interface to the user.

User device 110 may further include database 116 which may include, for example, identifiers such as operating system registry entries, cookies associated with check-in application 120, payment application 112, and/or other applications 114, identifiers associated with hardware of user device 110, or other appropriate identifiers, such as identifiers used for payment/user/device authentication or identification. In one embodiment, identifiers in database 116 may be used by user device 110, merchant device 130, and/or payment provider server 150, to associate user device 110 with a particular account maintained by payment provider server 150. Database 116 may include information for check-in application 120 including previously used identifiers, newly generated identifiers, and/or obfuscated identifiers.

Database 116 may further include identifiers for merchant device 130 and/or payment provider server 150 for use in communication with merchant device 130 and/or payment provider server 150 after check-in. User account information for an account with merchant device 130, such as a loyalty account, may be stored in database 116. Additionally, a digital wallet including benefits for use with merchant device 130 may be included in database 116. Database 116 may also store merchant information, including an identifier for merchant device 130. Database 116 may include transaction histories usable to present proof of purchase of food items for payment provider server 150.

Database 116 may include information used by payment application 112, for example, user personal information (e.g. a name, social security number, user financial information, or other identifying information), a user account identifier (e.g. user account identifier is at least one of a user identifier, a user credit or debit card number, a user account name, and a user account number), and/or a user device identifier. In various embodiments, database 116 may include online account access information.

In various embodiments, user device 110 includes at least one network interface component 118 adapted to communicate with merchant device 130 and/or payment provider server 150. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 118 may include a communication module for short range communications with merchant device 130 including microwave, radio frequency, infrared, Bluetooth, and near field communication devices.

Merchant device 130 may correspond, for example, to a merchant or seller offering various items and/or services for sale to user 102 through a merchant location. Generally, merchant device 130 may be maintained by anyone or any entity that receives money in exchange for items and/or services, which may include retail merchants, restaurants, service locations (e.g., airports, hospitals, hotels, etc.), and/or charities. In this regard, merchant device 130 may include processing applications, which may be configured to interact with user device 110 and/or payment provider server 150 to provide check-in services and facilitate the sale of items and/or services. Although merchant device 130 is described as separate from payment provider server 150, it is understood that one or more of the described functions of payment provider server 150 may be incorporated within merchant device 130, and vice versa.

Merchant device 130 may be implemented using any appropriate hardware and software configured for wired and/or wireless communication with user device 110 and/or payment provider server 150. For example, in one embodiment, merchant device 130 may be implemented as a single or networked personal computer (PC), a smart phone, laptop computer, a point of sale (POS) terminal, and/or other types of computing devices at a merchant location capable of transmitting and/or receiving data. In other embodiments, merchant device 130 may correspond to a networked server for a plurality of merchant locations, such as a chain retailer and/or online website. Although only one merchant is shown, a plurality of different merchants may be utilized.

Merchant device 130 includes a check-in application 140, a sales application 132, other applications 134, a database 136, and a network interface component 138. Check-in application 140, sales application 132, and other applications 134 may correspond to processes, procedures, and/or applications executable by a hardware processor, for example, a software program. In other embodiments, merchant device 130 may include additional or different software as required.

Check-in application 140 may correspond to processes to complete check-in with user device 110. Thus, check-in application 140 may correspond to merchant device 130's application configured to transmit and/or receive a check-in request from user device 110 and complete the check-in request using cheek-in information from user device 110. Check-in application 140 may receive the check-in information directly from user device 110, and/or over network 160 from user device 110 or payment provider server 140. Thus, in certain embodiments, payment provider server 140 may include a check-in application configured to complete a check-in for user 102 with merchant device 130 and/or pass check-in information to check-in application 140.

As previously discussed, the check-in information may comprise an identifier for user 102, which in various embodiments may be unknown to merchant device 130 to enable an anonymous check-in for user 102. In such embodiments, check-in application 140 may associate user 102 with a first time user status, such as a new customer status or a new visitor to a specific merchant location status. Thus, based on this status, check-in application 140 may offer first time benefits to the user through the user device. First time benefits may be offered to users that check-in with merchant device 130 having never checked-in before with merchant device 130. First time benefits may include benefits such as loyalty account enrollment, merchant information (merchant maps, offered items/services, sales associate locations, etc.), available sales and/or discounts, and/or sales associate help. Thus, user 102 may receive these first time benefits through user device 110 if user 102 is checked-in anonymously with check-in application 140.

After check-in information is received by check-in application 140, a check-in may be completed between user device 110 and merchant device 130. The check-in with merchant device 130 may include storing an identifier in the check-in information so that user device 110 may be contacted and interacted with by merchant device 130 and vice versa. The check-in request may also include log in information for a user account in database 136, such as a loyalty account, and thus complete the check-in with user 102 by verifying the account information. However, in embodiments where a loyalty account has not been previously established by user 102, merchant device 130 may transmit a request to enroll in a loyalty program with merchant device 130 and establish a loyalty account. If user 102 accepts enrollment in the loyalty account, check-in application 140 may determine the required information for enrollment in the loyalty account. If the check-in information is sufficient for enrollment in the loyalty account, check-in application 140 may automatically complete enrollment in the loyalty account and transmit information about the loyalty account back to user 102, such as through an email, text, digital notification, etc. Additionally, check-in application 140 may forward the loyalty account information to a member of the merchant staff who may provide user 102 with a physical wallet card, keychain card, and/or printout. However, if additional user information is required from user 102, check-in application 140 may request the additional information prior to completing enrollment in the loyalty account. Check-in application 140 may verify the information against other information possessed by merchant device 130 to prevent duplicate loyalty accounts for user 102 and may present the information to be used for enrollment in the loyalty account to user 102 through user device 110 for verification.

Check-in application 140 may receive service requests from user device 110, as previously discussed. Check-in application 140 may transmit the service requests to members of the merchant staff through at least one staff device. Staff devices may correspond to a point of sale terminal, a terminal in an area of merchant staff members (e.g., a computer, a display screen, a telephone or intercom, etc.), an intercom system for a merchant location corresponding to merchant device 130, and/or a user device that members of the merchant staff may possess (e.g., a pager, a mobile phone, etc.). In certain embodiments, user 102 may have made the service request specific to a certain member of the merchant staff. Thus, check-in application 140 may determine a device that the member of the merchant staff is accessible by, such as a pager, mobile phone, and/or computer (or other terminal local to the member), and transmit the service request for user 102 to the specified member of the merchant staff through that device. If user 102 has made the service request specific to an area, an item, and/or a service, check-in application 140 may transmit the service request to the corresponding terminal for that area, item, and/or service, or to a device possessed by the merchant staff corresponding to the area, item, and/or service.

After a loyalty account for user 102 has either been accessed or established by check-in application 140, check-in application 140 may determine sales incentives, such as discount offers, for user 102 corresponding to the loyalty account. The sales incentives may be general to the loyalty account, such as available discounts, rebates, sales, etc., available at a merchant location corresponding to merchant device 130. However, in other embodiments, check-in application 140 may access past behavior of user 102 corresponding to the loyalty account, such as past user interactions at the merchant location (e.g., a time of a previous visit, a previous item purchased, and/or a previous amount spent). These past user interactions may be used to provide user 102 with sales incentives that may match the past user interactions, such as a discount for pastries if user 102 often shops in a bakery, a discount for $10 off a $100 purchase if the user often exceeds $100 while shopping, etc. In other embodiments, another application, such as a sales or discount application may calculate the incentives and discounts. Moreover, merchant device 130 and/or another merchant server may be the system determining the aforementioned incentives, sales, discounts, etc.

Check-in application 140 may also access a digital wallet for user 102 available from user device 110 and/or payment provider server 150 or in database 136. The digital wallet may include sales incentives, such as benefits for shopping at a merchant location corresponding to merchant device 130 (e.g., coupons, gift cards, discounts, rebates, etc.). Check-in application 140 may determine further sales incentives corresponding to the sales incentives available in the digital wallet. For example, if user 102 has a gift card in a digital wallet, merchant device 130 may provide user 102 with a time extension of the gift card or a discount when using the gift card to incentivize user 102 to utilize the gift card and/or revisit the merchant location. The digital wallet may include a coupon, rebate, or discount. Thus, merchant device 130 may provide an increase in value to the coupon, rebate, and/or discount if they are used while user 102 is at the merchant location.

Sales application 132 may be configured to provide sales information for a merchant location corresponding to merchant device 130 and complete sales transactions with user 102. In this regard, sales application 132 may provide information about a merchant location corresponding to merchant device 130 (e.g., maps, area locations, etc.), on available items and/or service with merchant device 130 (e.g., prices, benefits, sales incentives, etc.), and/or information for merchant staff available at the merchant location. Sales application 132 may be utilized to provide user device 110 with the aforementioned information. In other embodiments, check-in application 140 may retrieve the aforementioned information from sales application 132 and/or database 136. Sales application 132 may be further configured to complete sales transactions for the items and services with user device 110. Payment may be provided by user device 110 and/or payment provider server 150, such as through a payment account with payment provider server 150. Thus, sales application 132 may include payment processes configured to interact with user device 110 and/or payment provider server 150 to complete payment for items and/or services. Sales application 132 may further provide transaction histories for completed sales to user device 110 and/or payment provider server 150.

In various embodiments, merchant device 130 includes other applications 134 as may be desired in particular embodiments to provide features to merchant device 130. For example, other applications 134 may include security applications for implementing device/server-side security features, programmatic server applications for interfacing with appropriate application programming interfaces (APIs) over network 160, or other types of applications. Other applications 134 may contain software programs, executable by a processor, including a graphical user interface (GUI), configured to provide an interface to a user.

Merchant device 130 includes database 136. Database 136 may include item and/or service information, including inventory, prices, discounts, rebates, sales, etc. After completing payment, database 136 may include transaction history information. Database 136 may store other information relevant to merchant device 130, including loyalty account information for one or more loyalty accounts, identifiers used by users to check-in with merchant device 130, and user information.

In various embodiments, merchant device 130 includes at least one network interface component (NIC) 138 adapted to communicate with network 160 including user device 110 and/or payment provider server 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices. In various embodiments, network interface component 138 may include a communication module for short range communications with user device 110 including microwave, radio frequency, infrared, Bluetooth, and near field communication devices.

Payment provider server 150 may be maintained, for example, by an online payment service provider, which may provide payment services to user 102. In this regard, payment provider server 150 includes one or more processing applications, which may provide payment for items between user device 110 and merchant device 130. In one example, payment provider server 150 may be provided by PayPal®, Inc. of San Jose, Calif., USA. However, in other embodiments, payment provider server 150 may be maintained by or include a merchant, financial services provider, and/or other service provider, which may provide user account and payment services to user 102. Although payment provider server 150 is described as separate from merchant device 130, it is understood that one or more of the described functions of merchant device 130 may be incorporated within payment provider server 150 (e.g., processes and procedures described in reference to check-in application 140), and vice versa.

Payment provider server 150 of FIG. 1 includes a transaction processing application 152, other applications 154, a database 156, and a network interface component 158. Transaction processing application 152 and other applications 154 may correspond to processes, procedures, and/or applications executable by a hardware processor, for example, a software program. In other embodiments, payment provider server 150 may include additional or different software as required.

Transaction processing application 152 may be configured to receive information from user device 110 and/or merchant device 130 for processing and completion of financial transactions. Transaction processing application 152 may include one or more applications to process financial transaction information from user device 110 and/or merchant device 130. Transaction processing application 152 may receive a payment request to complete a sale transaction for an item and/or service. Transaction processing application 152 may complete the sale transaction by providing payment to merchant device 130. Transaction processing application 152 may receive a user payment account for user 102 with payment provider server 150 in order to provide payment to merchant device 130. In other embodiments, transaction processing application 152 may receive user financial information, such as a payment card, bank account, gift card, or other financial information. Transaction processing application 152 may credit the payment to a payment account of merchant device 130 with payment provider server 150 or to another financial account, such as a bank account. In other embodiments, transaction processing application 152 may provide transaction histories, including receipts, to user device 110 and/or merchant device 130 in order to provide proof or purchase and complete the financial transaction.

In various embodiments, payment provider server 150 includes other applications 154 as may be desired in particular embodiments to provide features to payment provider server 150. For example, other applications 154 may include security applications for implementing server-side security features, programmatic server applications for interfacing with appropriate application programming interfaces (APIs) over network 160, or other types of applications. Other applications 154 may contain software programs, executable by a processor, including a graphical user interface (GUI), configured to provide an interface to a user. In certain embodiments, other application 154 may include check-in applications configured to provide check-in services for user 102 with merchant device 130, as previously discussed.

Additionally, payment provider server 150 includes database 156. User 102 and/or merchant device 130 may establish one or more user accounts with payment provider server 150 that provide payment processing. User accounts in database 156 may include user/merchant information, such as name, address, birthdate, payment/funding information, additional user financial information, and/or other desired user data. User 102 and merchant device 130 may link user accounts to user device 110 through a user, merchant, and/or device identifier. Thus, when an identifier is transmitted to payment provider server 150, e.g. from user device 110 and/or merchant device 130, a user account belonging to user 102 and/or merchant device 130 may be found. In other embodiments, user 102 and/or merchant device 130 may not have previously established a user account and may provide other financial information to payment provider server 150 to complete financial transactions.

In various embodiments, payment provider server 150 includes at least one network interface component (NIC) 148 adapted to communicate with network 160 including user device 110 and/or merchant device 130. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

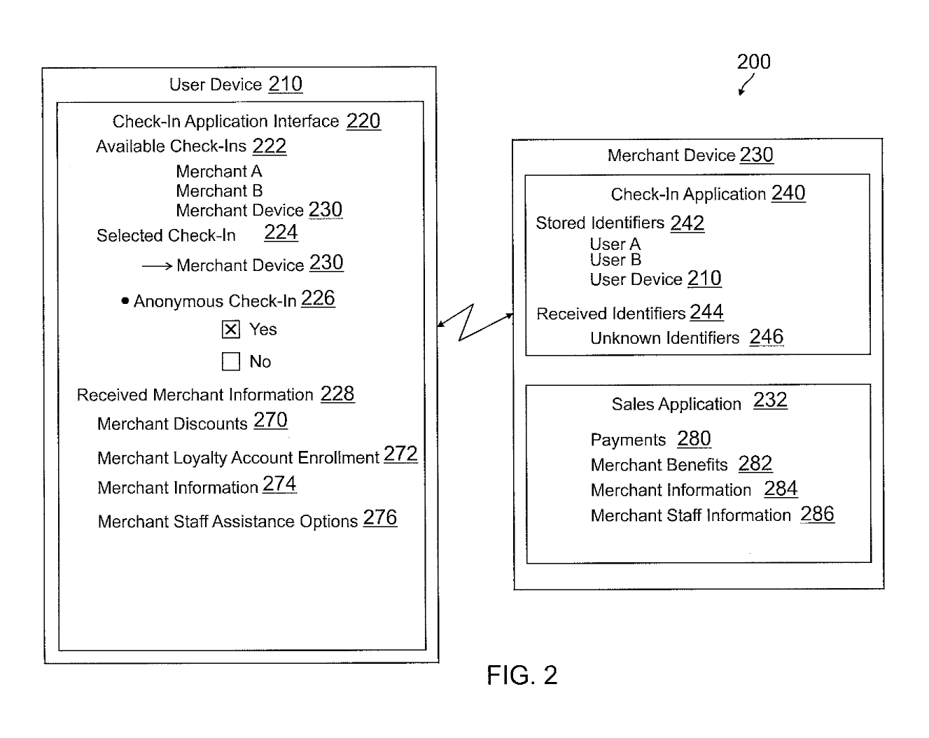

FIG. 2 is an exemplary system environment displaying a user opting for an anonymous check-in with a user device when visiting a merchant location, according to an embodiment. FIG. 2 includes a user device 210 and a merchant device 230 corresponding generally to user device 110 and merchant device 130, respectively, of FIG. 1.

As shown in FIG. 2, user device 210 interacts with merchant device 230 to complete an anonymous check-in of user device 210 (and the associated user, not shown). User device 210 displays a check-in application interface 220 for use when checking in with merchant device 230. Check-in application interface 220 may correspond to an interface displaying similar executed processes and procedures of check-in application 120 of FIG. 1. In various embodiments, a check-in application for check-in application interface 220 may execute in the background of user device 210, as previously discussed and automatically check-in user device 210 with the available check-in devices under available check-ins 222. In such embodiments, a user of user device 210 may be required to previously set an option in check-in application interface 220 for anonymous check-in or may be prompted for an anonymous check-in on each check-in available under available check-ins 222. However, in the embodiment of FIG. 2, the user of user device 210 is actively engaging in a check-in process with merchant device 230. Thus, the user has selected a check-in device under available check-ins 222 as shown in a selected check-in 224. Selected check-in 224 shows merchant device 230 selected to complete a check-in process.

After selecting merchant device 230 as selected check-in 224, check-in application interface 220 may display an option under selected check-in 224 shown as an anonymous check-in 226. Anonymous check-in 226 includes boxes for a user of user device 210 to choose to check-in to merchant device 230 anonymously. Anonymous check-in may always appear on check-in with a device, or may appear if check-in application interface 220 determines user device 210 has previously checked-in with merchant device 230.

In FIG. 2, the user has selected to complete an anonymous check-in under anonymous check-in 226. Thus, check-in application interface 220 may perform an anonymous check-in with merchant device 230 by transmitting an identifier or other check-in information to merchant device 230 that does not identify user device 210 and/or the user of user device 210 to merchant device 230, or may transmit nothing at all (e.g., be unresponsive to requests to check-in with merchant device 230). For example, user device 210 may transmit an obfuscated, new, or unknown identifier to merchant device 230. Any check-in information sent to merchant device 230 may therefore not provide merchant device 230 with an identification of user device 210 and/or the user of user device 210. Additionally, selection of anonymous check-in 226 may limit check-in information transmitted to merchant device 230 so that a name, address, email, phone number, or other personal information for the user of user device 210 is not transmitted to merchant device 230. As previously discussed, in certain embodiments, it may not be user device 210 transmitting an identifier or other check-in information to merchant device 230. For example, user device 210 may instruct a cloud service having check-in features to provide anonymous check-in with merchant device 230. Thus, the cloud service may provide the new, obfuscated, or otherwise hidden check-in information to merchant device 230.

Merchant device 230 may receive the check-in information from user device 210 and utilize a check-in application 240 to complete a check-in for user device 210. Check-in application 240 may correspond to similar processes and procedures of check-in application 140 of FIG. 1. As shown in FIG. 2, check-in application 240 includes stored identifiers 242 and further includes received identifiers 244 having an unknown identifier 246 received from user device 210. Utilizing check-in application 240, merchant device compares unknown identifier 246, such as the obfuscated, new, or unknown identifier, to stored identifiers 242. Since user device 210 has used an identifier that is not available to check-in application 240 (e.g., not in the system of merchant device 230), unknown identifier 246, under stored identifiers 242, check-in application 240 may perform an anonymous check-in of user device 210 and treat user device 210 as though it has never checked-in with merchant device 230.

Merchant device 230 may also execute a sales application 232 that may provide information to user device 210 based on user device 210's anonymous check in. Sales application 232 may correspond to similar processes and procedures of sales application 132 of FIG. 1. Sales application 232 includes payments 280, merchant benefits 282, merchant information 284, and merchant staff information 286. Payments 280 may correspond to a payment process configured to complete payments with user device 210 based on a check-in with merchant device 230. Merchant benefits 282 may correspond to discounts and/or loyalty account information and enrollment processes. Thus, merchant device 230 may transmit merchant benefits 282 to user device 210 for display in check-in application interface 230 under received merchant information 228 as merchant discounts 270 and merchant loyalty account enrollment 272. Merchant discounts 270 and/or merchant loyalty account enrollment 272 may correspond to selectable options to view discounts and/or enroll in a loyalty account, respectively.

Sales application 232 also includes merchant information 284 that may correspond to maps, locations, items/services offered, or other merchant information. Sales application 232 may transmit merchant information 284 to user device 210 for display in check-in application interface 230 under received merchant information 228 as merchant information 274. Received merchant information 228 may correspond to informational displays and/or selectable buttons/menus that may request and/or display the information available under merchant discounts 270, merchant loyalty account enrollment 272, and/or merchant information 274. Additionally received merchant information 228 includes merchant staff assistance options 276 that may correspond to an option to transmit service requests or other requests for merchant staff service assistance from merchant device 230. Thus, sales application 232 includes merchant staff information 286 that may include information necessary for merchant device 230 to complete service requests or other requests for merchant staff service assistance from user device 210.

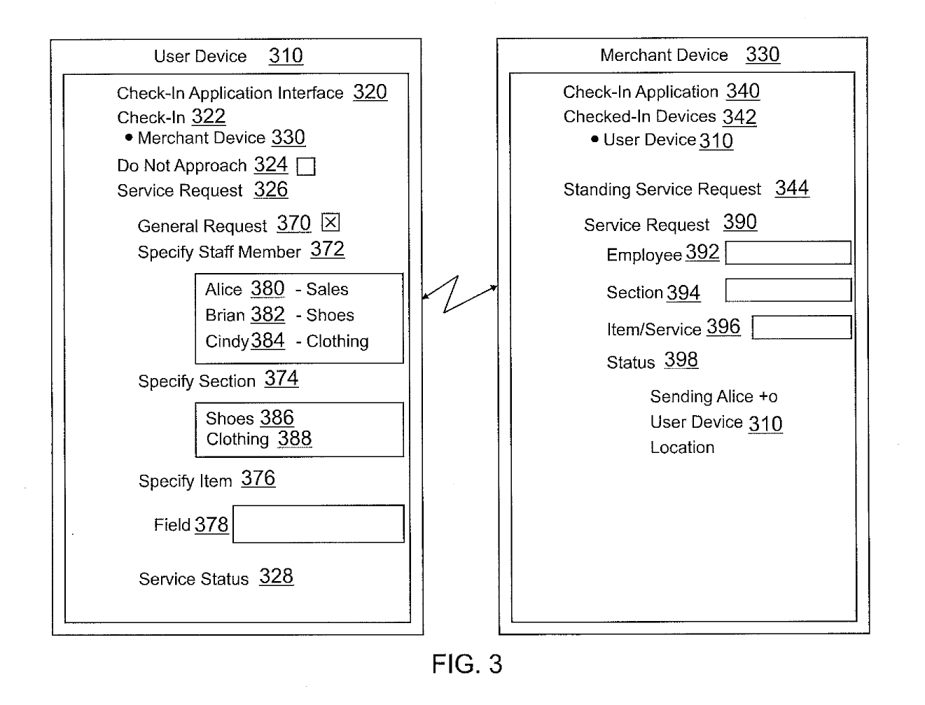

FIG. 3 is an exemplary system environment displaying a user device selecting interactions with merchant staff after a check-in at a merchant location, according to an embodiment. FIG. 3 includes a user device 310 and a merchant device 330 corresponding generally to user device 110 and merchant device 130, respectively, of FIG. 1.

User device 310 of FIG. 3 displays a check-in application interface 320 after completion of a check-in with merchant device 330. Check-in application interface 320 may correspond to an interface displaying similar executed processes and procedures of check-in application 120 of FIG. 1. Check-in application interface 320 enables a user of user device 310 to transmit service requests to merchant device 330 that correspond to merchant staff available at a merchant location for merchant device 330. Check-in application interface 320 displays a check-in 322, which displays to the user of user device 310 that user device 310 is checked-in with merchant device 330. Additionally, check-in application interface 320 displays an option for a “do not approach” service request as do not approach 324 button. If the user selects do not approach 324 in check-in application interface 320, a do not approach message may be transmitted to merchant device 330 that instructs all of the merchant staff at the merchant location for merchant device 330 to not approach or leave the user of user device 310 alone.

However, as shown in FIG. 3, a user of user device 310 has selected an option under a service request 326 tab. Service request 326 tab may include options for various types of service requests for assistance for a merchant staff corresponding to merchant device 330. Thus, service request 326 includes a general request 370, a specify staff member 372 option, a specify section 374 option, and a specify item 376 option. Generally request 370 corresponds to a request for general help by the user of user device 310, and may include a request to send the nearest, next available, or any member of the merchant staff to the user of user device 310. General request 370 is shown as selected in FIG. 3, thus, the user is requesting general help from the staff members.

Specify staff member 372 includes the option for a user of user device 310 to select a specific staff member to assist the user. For example, the user may have a preference, be recommended, or know a specific staff member. Specify staff member 372 may also include information corresponding to each staff member to enable the user to make a more specific selection for assistance. Specify staff member 372 includes Alice 380, Brian 382, and Cindy 382. Alice 380 is shown with the sales designation, Brian 382 with the shoes designation, and Cindy 384 with the clothing designation. Thus, if the user of user device 310 would prefer help in sales, shoes, or clothing, or knows/prefers Alice, Brian, or Cindy, the user may select one of these merchant staff members. Other types of merchants offering selection of specific staff members may include restaurants, service businesses (e.g., hair/nail salons, spas, gyms, etc.), taxi/car travel providers, etc.

Specify section 374 includes the option for a user of user device 310 to select a specific area or section of a merchant location corresponding to merchant device 330 to request assistance. Thus, if the user for user device 310 happens to be located in a section (e.g., butcher, bakery, shoes, golf, car service, sales, returns, etc.), the user may request help for that specific station. Specify section 374 includes shoes 386 and clothing 388. By selecting shoes 386 or clothes 388, the user of user device may direct the request for service assistance directly to that area.

Specify item 376 enables a user of user device 310 to specify a specific item for help with while at a merchant location corresponding to merchant device 330 (e.g., help finding a new golf club, with a car wash, etc.). If the user wishes to search and/or request help for finding a specific item or service, the user may utilize field 378 in specify item 376 to enter that item/service. Thus, field 378 may correspond to a text field where the user may enter the item or service name, identifier, information, etc. While, specify staff member 372 and specify section 374 are shown as lists and specify item 376 is shown with field 378, it is understood any data entry format (e.g., list, voice input, text field, intelligent search, etc.) may be utilized in each of specify staff member 372, specify section 374 and specify item 376.

Check-in application 340 may receive the service request from user device 310 and process the service request to send one or more members of a merchant staff corresponding to a merchant location for merchant device 330 to a user of user device 310. As shown in FIG. 3, check-in application 340 includes checked-in devices 342 that includes user device 310. Additionally, check-in application 340 includes standing service request 344, which may include outstanding service requests receiving from one or more user devices, such as user device 310. Standing service requests 344 includes service request 390, which may correspond to the received service request from user device 310. Since user device 310 transmitted general request 370 to merchant device 330, service request 390 may correspond to a general request for service from the merchant staff. However, service request 390 may include other parameters, such as an employee 392, a section 394, and an item/service 396. Employee 392 may correspond to a specific employee designated for the service request, such as one under specify staff member 372. Section 394 may correspond to a specific area or section of a merchant location corresponding to merchant device 330 specified under specify section 374. Additionally, item/service 396 may correspond to a specific item or service specified under specify item 376. Since service request 390 corresponds to a general service request, employee 392, section 394, and item/service 396 are blank. However, other embodiments may include information under each section depending on the type of assistance requested by the user of user device 310.

Once service request 390 is received, merchant device 390 may distribute the service request to the appropriate member(s) of the merchant staff, as previously discussed. For example, a request for general assistance may be transmitted to each staff member's user device, nearby staff member's user devices and/or terminals, and/or over an intercom system. Once the service request is transmitted to staff members, check-in application 340 may receive updates about the member(s) of the merchant staff that may assist the user. For example, check-in application 340 may receive updates for the name, identifier, and/or time to assistance for the member of the merchant staff that will be assisting the user of user device 310. Such information may be incorporated under a status 398. Status 398 includes “Sending Alice to User Device 310 Location.” Thus, status 398 may display that Alice is assisting the user of user device 310. Additionally, status 398 may be transmitted to user device 310 and appear under service status 328. Therefore, the user of user device 310 may view status 398 under service status 328.

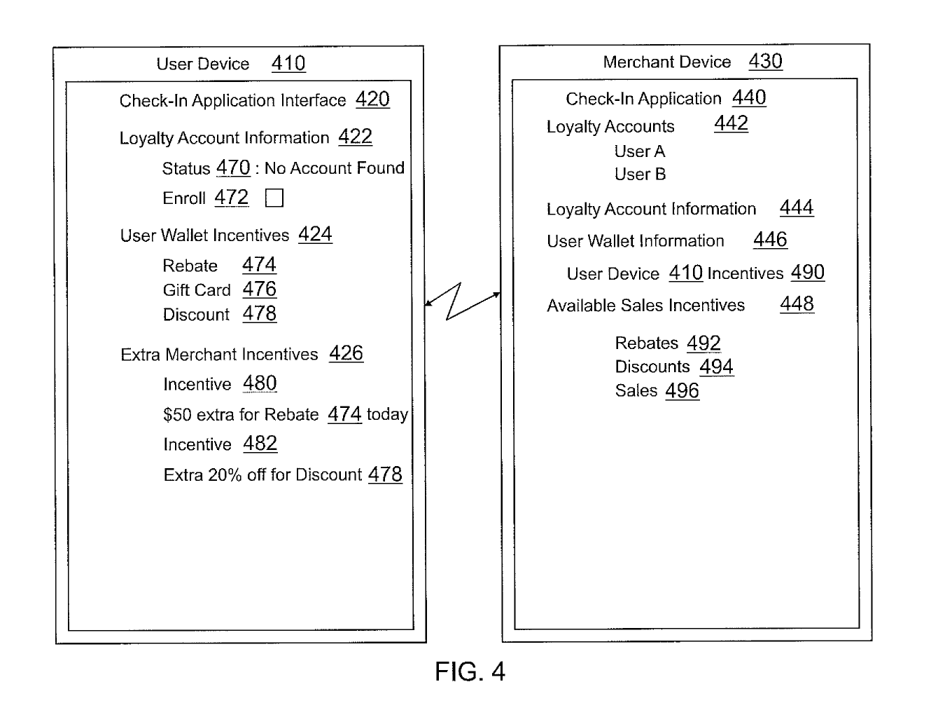

FIG. 4 is an exemplary system environment displaying a user device providing sales incentives to a user after a check-in at a merchant location, according to an embodiment. FIG. 4 includes a user device 410 and a merchant device 430 corresponding generally to user device 110 and merchant device 130, respectively, of FIG. 1.

User device 410 of FIG. 4 displays a check-in application interface 420 after completion of a check-in with merchant device 430. Check-in application interface 420 may correspond to an interface displaying similar executed processes and procedures of check-in application 120 of FIG. 1. After completion of a check-in with merchant device 430, check-in application 440 may determine if, based on the received check-in information, a user of user device 410 has a loyalty account with merchant device 430 or a merchant corresponding to merchant device 430. Check-in application 440 may correspond generally to the processes and procedures of check-in application 140 of FIG. 1. Check-in application 440 includes loyalty accounts 442 having user A and user B. Loyalty accounts 442 may correspond to established loyalty accounts. Loyalty accounts 442 may further include information for each loyalty account for user A and user B, such as past behavior with a merchant/merchant location corresponding to merchant device 430. The past behavior may correspond to past purchases, last dates visited to the merchant location, and/or past amounts spent. The past behaviors may be utilized to provide sales incentives the holders of loyalty accounts 442, such as discounts based on a past amount spent, frequent shopper discounts, larger discounts for infrequent shoppers to encourage purchases and future visits, etc.

Since user device 410, or the user of user device 410, is not listed under loyalty accounts 442, merchant device 430 may determine that the user does not possess a loyalty account. Thus, check-in application 440 may transmit a request to establish a loyalty account to user device 410. The request to establish a loyalty account transmitted to user device 410 may include loyalty account information 444 that may correspond to required information to establish a loyalty account, terms of the loyalty account, and benefits for having the loyalty account, such as sales incentives.

User device 410 may receive the request to establish the loyalty account and present the request to a user of user device 410 through check-in application interface 420. Thus, check-in application interface 420 displays loyalty account information 422 that displays a status of the user's loyalty account, shown as “No account found,” and enroll 472 option. By selecting enroll 472, the user may establish a loyalty account with merchant device 430. The loyalty account may be established using check-in information provided by user device 410 to merchant device 430. However, in other embodiments, merchant device 430 may require additional information and thus by selecting enroll 472, check-in application interface 420 may display a form, menu, and/or options to enter in information required by merchant device 430 for the establishment of a loyalty account. Once a loyalty account is established, user device 410 may display sales incentives provided by the loyalty account.

Check-in application 440 may also access a digital user wallet that includes sales incentives. Thus, check-in application 440 includes user wallet information 446 that includes user device 410 incentives 490. User wallet information 446 may include information from digital wallet for a user in a database of user device 410, merchant device 430, or another source providing the digital wallet, such as a payment provider server. User device 410 incentives 490 may correspond to sales incentives that are already possessed by the holder of the digital wallet, such as a user of user device 410. User device 410 incentives 490 may correspond to gift cards, discounts, coupons, rebates, etc., that incentivize the user to purchase items and/or services at a merchant location corresponding to merchant device 430. Utilizing user device 410 incentives 490, check-in application 440 may determine one or more related sales incentive that may further incentivize the user to utilize user device 410 incentives 490 and/or purchase items/services at the merchant location. Thus, check-in application 440 includes available sales incentives 448 having rebates 492, discounts 494, and sales 496. Each of rebates 492, discounts 494, and sales 496 correspond to a further sales incentives that may be offered to the user of user device 410. Utilizing available sales incentives 448, check-in application 440 may transmit sales incentives corresponding to user device 410 incentives 490 to user device 410.

A user of user device 410 may view available sales incentives already held by the user under user wallet incentives 424. User wallet incentives 424 include a rebate 474, a gift card 476, and a discount 478. Each of rebate 474, gift card 476, and discount 478 correspond to currently available sales incentives held by the user in a digital wallet. Thus, the user may be informed of sales incentives by merchant device 430 when checking in with merchant device 430.

Additionally, under extra merchant incentives 426, a user of user device 410 may view additional sales incentives offered by merchant device 430 that correspond to rebate 474, gift card 476, and/or discount 478. An incentive 480 includes an incentive for an extra $50 back when using rebate 474. An incentive 482 includes an incentive for an extra 20% off for using discount 478. Incentives 480 and 482 may be populated from information available in available sales incentives 448, such as rebates 492 and discounts 494. Thus, merchant device 430 may further incentivize the user to utilize rebate 474 and discount 478 through incentive 480 and incentive 482, respectively.

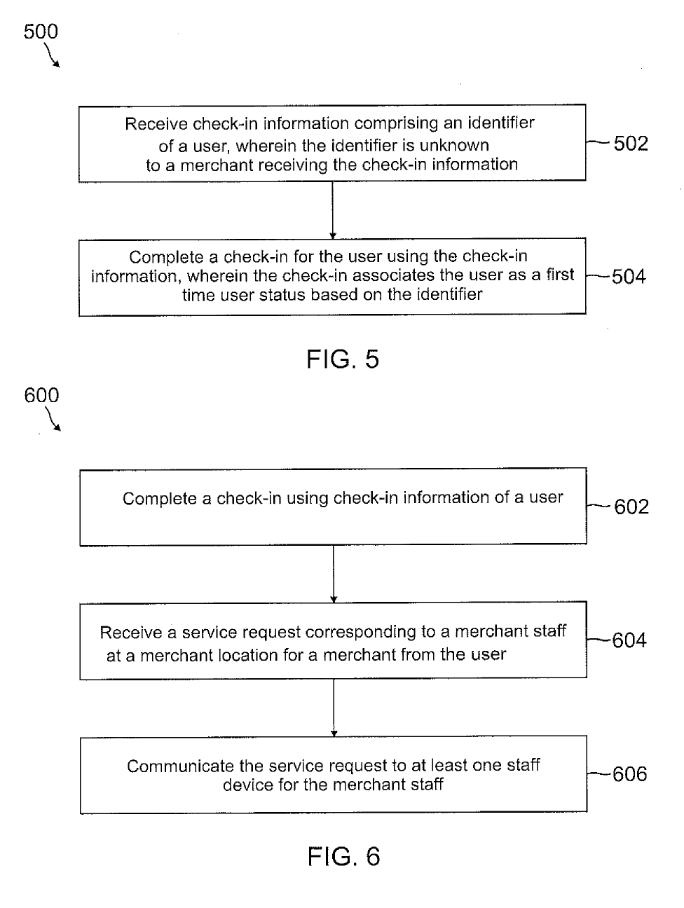

FIG. 5 is a flowchart of an exemplary process for anonymous check-in at a merchant location, according to an embodiment. Note that one or more steps, processes, and methods described herein may be omitted, performed in a different sequence, or combined as desired or appropriate.

At step 502, check-in information comprising an identifier of a user is received, wherein the identifier is unknown to a merchant receiving the check-in information. The check-in information may be received by a merchant device at a merchant location or from a server offering check-in services to the merchant. The identifier in the check-in information may be obfuscated from a previous identifier used to check-in with the merchant to generate the identifier. For example, a user device may obfuscate the previous identifier by scrambling data of the previous identifier, adding or removing values in the data of the previous identifier, and/or changes the values of the data of the previous identifier. In other embodiments, a different identifier from a previous identifier used with the merchant may be utilized as the identifier.

The user may select an anonymous check-in preference with the user device prior to transmitting the check-in information to the merchant. In other embodiments, the user may select an anonymous check-in preference with the user device on a request for the check-in information from the merchant.

At step 504, a check-in for the user is completed using the check-in information, wherein the check-in associates the user as a first time user status based on the identifier. After completion of the check-in, first time benefits may be offered to the user through a user device, wherein the first time benefits are offered to a plurality of users based on the first time user status. The first time benefits may comprise at least one of a loyalty account enrollment, merchant information, available sales and discounts, and sales associate help. Additionally, the first time user status may comprise one of a new customer status and a new visitor to a specific merchant location status. For example, the identifier used with the merchant may be utilized at another merchant location for the merchant. However, the merchant may associate the user as a first time user at the merchant location where the user is currently located.

FIG. 6 is a flowchart of an exemplary process for merchant staff interactions through a user device check-in at a merchant location, according to an embodiment. Note that one or more steps, processes, and methods described herein may be omitted, performed in a different sequence, or combined as desired or appropriate.

At step 602, a check-in using check-in information of a user is completed. The check-in information used to complete the check-in may be received by a merchant device at the merchant location. In other embodiments, check-in information may be received from a server offering check-in services to the merchant.

A service request corresponding to a merchant staff at a merchant location for a merchant is received from the user, at step 604. The service request may comprise a message for the merchant staff to not approach the user at the merchant location. Conversely, the service request may comprise a request for service from the merchant staff at the merchant location. The service request may be specific to a member of the merchant staff, such as a known member of the merchant staff by the user, or a selection of the member in a menu. The service request may also be specific to an area, item, or service at the merchant location.

At step 606, the service request is communicated to at least one staff device for the merchant staff. Generally, the at least one staff device may comprise a point of sale terminal, a user device, and an intercom system device. Where the service request is specific to a member of the merchant staff, the at least one staff device may be a terminal in an area of the member of the merchant staff or a device possessed by the member of the merchant staff. Moreover, where the service request is specific to an area, item, or service, the at least one staff device may be one of a terminal corresponding to the area, the item, or the service at the merchant location or a device possessed by the merchant staff corresponding to the area, the item, or the service at the merchant location.

After communicating the service request to the at least one staff device, the user may be alerted through the user device of assistance information for the merchant staff corresponding to the service request. The assistance information may comprise at least one of a name of a member of the merchant staff assisting the user, a picture of the member of the merchant staff, and an approximate time to assistance provided by the member of the merchant staff.

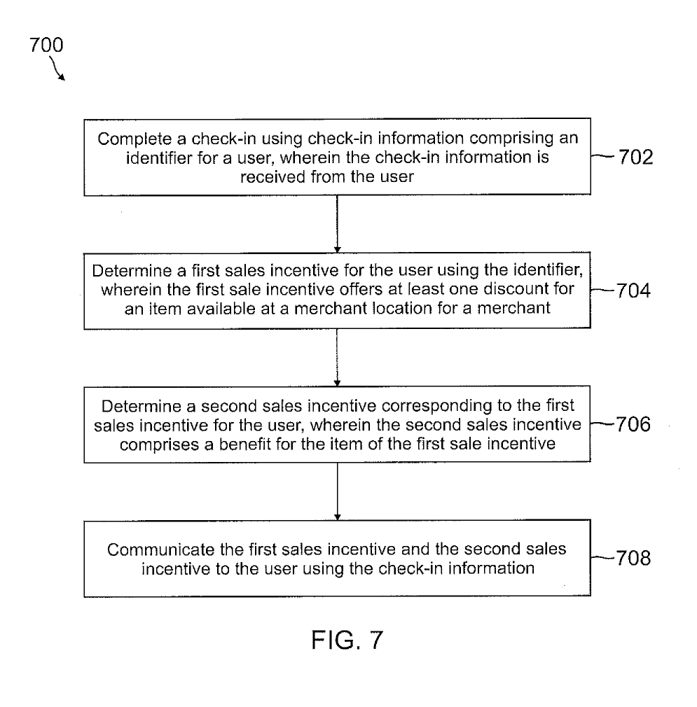

FIG. 7 is a flowchart of an exemplary process for providing sales incentive information after a user device check-in at a merchant location, according to an embodiment. Note that one or more steps, processes, and methods described herein may be omitted, performed in a different sequence, or combined as desired or appropriate.

At step 702, a check-in is completed using check-in information comprising an identifier for a user, wherein the check-in information is received from the user. As above, the check-in information to complete the check-in may be received by a merchant device at the merchant location. In other embodiments, the check-in information may be received from a server offering check-in services to the merchant. A first sales incentive for the user is determined using the identifier, wherein the first sale incentive offers at least one discount for an item available at a merchant location for a merchant, at step 704.

At step 706, a second sales incentive corresponding to the first sales incentive for the user is determined, wherein the second sales incentive comprises a benefit for the item of the first sale incentives. The first sales incentive and the second sales incentive is communicated to the user using the check-in information, at step 708. The first sales incentive may comprise a loyalty account status for a loyalty account with the merchant, and wherein the second sales incentive may comprise a discount offer using the loyalty account.

If the user does not possess a loyalty account, a request for enrollment in the loyalty account may be transmitted to the user based on the loyalty account status (e.g., no loyalty account). User information may be requested from the user for the enrollment in the loyalty account if the user accepts the request. The user information may be from the user device and the enrollment in the loyalty account may be completed using the user information.

In other embodiments, after transmitting the request for enrollment in the loyalty account to the user, the enrollment in the loyalty account may be completed using check-in information if the user accepts the request. The user may be provided with loyalty account information corresponding to the loyalty account, wherein the loyalty account information may be provided as at least one of an email, a text, a digital notification, a wallet card, a keychain card, and a printout.

Once the user has a loyalty account, the loyalty account may comprise past user interactions at the merchant location, and wherein the discount offer corresponds to the past user interactions. The past user interactions may comprise at least one of a previous visit time to the merchant location, a previous item purchased with the merchant, and a previous amount spent with the merchant.

In various embodiments, the first sales incentive may comprise a first user benefit in a digital wallet of the user, and wherein the second sales incentive comprises a second user benefit corresponding to the first user benefit and offered by the merchant. For example, the first user benefit may comprise a gift card and the second user benefit may comprise a time extension or discount for using the gift card. In other embodiments, the first user benefit may comprise at least one of a coupon, rebate, and discount and the second user benefit may comprise a value increase in the at least one of a coupon, rebate, and discount.

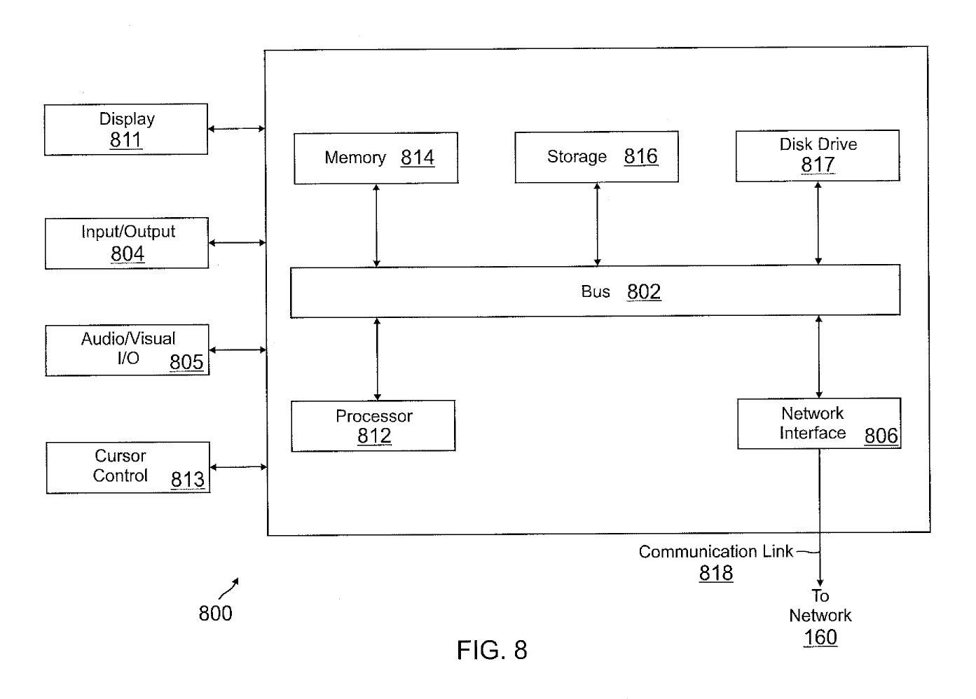

FIG. 8 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another user device, a merchant server, or a service provider server via network 160. In one embodiment, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various embodiments, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing check-in information for a user; and
one or more hardware processors in communication with the non-transitory memory and configured to:
process a check-in using the check-in information comprising an identifier for the user, wherein the check-in information is received from a user device of the user;
determine a loyalty account status for a loyalty account with a merchant;
transmit a request for enrollment in the loyalty account to the user based on the loyalty account status; and
establish the enrollment in the loyalty account for the user when the user accepts the request.

2. The system of claim 1, wherein prior to the one or more hardware processors establishing the enrollment in the loyalty account, the one or more hardware processors are further configured to:
request user information from the user for the enrollment in the loyalty account; and
receive the user information from the user device,
wherein the enrollment in the loyalty account is further established using the user information.

3. The system of claim 2, wherein the one or more hardware processors are further configured to:
provide the user with loyalty account information corresponding to the loyalty account, wherein the loyalty account information is provided as at least one of an email, a text, a digital notification, a wallet card, a keychain card, and a printout.

4. The system of claim 1, wherein the enrollment in the loyalty account is established using the check-in information or the identifier, and wherein the one or more hardware processors are further configured to:
provide the user with loyalty account information corresponding to the loyalty account, wherein the loyalty account information is provided as at least one of an email, a text, a digital notification, a wallet card, a keychain card, and a printout.

5. The system of claim 1, wherein the one or more hardware processors are further configured to:
determine a discount offer for the user using the loyalty account, wherein the discount offer comprises at least one discount for an item available at a merchant location for the merchant; and
communicate the discount offer to the user device using the check-in information.

6. The system of claim 5, wherein the loyalty account comprises past user interactions at the merchant location, and wherein the discount offer corresponds to the past user interactions.

7. The system of claim 6, wherein the past user interactions comprise at least one of a previous visit time to the merchant location, a previous item purchased with the merchant, and a previous amount spent with the merchant.

8. A method comprising:
processing, using one or more hardware processors, a check-in using check-in information comprising an identifier for a user, wherein the check-in information is received from a user device of the user;
determining a loyalty account status for a loyalty with a merchant;
transmitting a request for enrollment in the loyalty account to the user based on the loyalty account status; and
establishing the enrollment in the loyalty account for the user if the user accepts the request.

9. The method of claim 8, wherein prior to establishing the enrollment in the loyalty account, the method further comprises:
requesting user information from the user for the enrollment in the loyalty account if the user accepts the request; and
receiving the user information from the user device,
wherein the enrollment in the loyalty account is further established using the user information.

10. The method of claim 9 further comprising:
providing the user with loyalty account information corresponding to the loyalty account, wherein the loyalty account information is provided as at least one of an email, a text, a digital notification, a wallet card, a keychain card, and a printout.

11. The method of claim 8, wherein the enrollment in the loyalty account is established using the check-in information or the identifier.

12. The method of claim 8 further comprising:
determining a discount offer for the user using the loyalty account, wherein the discount offer comprises at least one discount for an item available at a merchant location for the merchant; and
communicating the discount offer to the user device using the check-in information.

13. The method of claim 12, wherein the loyalty account comprises past user interactions at the merchant location, and wherein the discount offer corresponds to the past user interactions.

14. The method of claim 13, wherein the past user interactions comprise at least one of a previous visit time to the merchant location, a previous item purchased with the merchant, and a previous amount spent with the merchant

15. A system comprising:
a non-transitory memory storing check-in information for a user; and
one or more hardware processors in communication with the non-transitory memory and configured to:
process a check-in using the check-in information comprising an identifier for the user, wherein the check-in information is received from a user device of the user;
determine a first sales incentive for the user using the identifier, wherein the first sale incentive offers at least one discount for an item available at a merchant location for a merchant;
determine a second sales incentive corresponding to the first sales incentive for the user, wherein the second sales incentive comprises a benefit for the item of the first sale incentives; and
transmit the first sales incentive and the second sales incentive to the user device using the check-in information.

16. The system of claim 15, wherein the first sales incentive comprises a first user benefit in a digital wallet of the user, and wherein the second sales incentive comprises a second user benefit corresponding to the first user benefit and offered by the merchant.

17. The system of claim 16, wherein the first user benefit comprises a gift card, and wherein the second user benefit comprises a time extension or discount for using the gift card.

18. The system of claim 16, wherein the first user benefit comprises at least one of a coupon, rebate, and discount, and wherein the second user benefit comprises a value increase in the at least one of a coupon, rebate, and discount.

19. The system of claim 15, wherein the check-in information is received by a merchant device at the merchant location.

20. The system of claim 15, wherein the check-in information is received from a server offering check-in services to the merchant.
